(19) United States
(12) Patent Application Publication
(10) Pub. No.: US 2026/0208043 A1
(43) Pub. Date: Jul. 23, 2026

(54) INTERACTIVE ANIMATION PROCESSING METHOD AND DEVICE, STORAGE MEDIUM AND ELECTRONIC DEVICE

(71) Applicant: NETEASE (HANGZHOU) NETWORK CO., LTD., Hangzhou, Zhejiang (CN)

(72) Inventors: Mengyuan DING, Hangzhou, Zhejiang (CN); Jinbin OUYANG, Hangzhou, Zhejiang (CN)

(73) Assignee: NETEASE (HANGZHOU) NETWORK CO., LTD., Hangzhou, Zhejiang (CN)

(21) Appl. No.: 19/138,232

(22) PCT Filed: May 23, 2023
(86) PCT No.: PCT/CN2023/095879

§ 371 Date: Jun. 12, 2025

(30) Foreign Application Priority Data
Dec. 12, 2022 (CN) 202211590835.8

(51) Int. Cl. A63F 13/52; A63F 13/533; A63F 13/54; A63F 13/92

(52) U.S. Cl. CPC A63F 13/52; A63F 13/533; A63F 13/54; A63F 13/92

(57) ABSTRACT

Disclosed are an interactive animation processing method and device, a storage medium and an electronic device. The method includes: in response to a controlled virtual character executing a first game behavior in a game scene, acquiring a first sound value of the controlled virtual character before the first game behavior is executed and a second sound value after the first game behavior is executed; according to the first sound value and the second sound value, determining a target animation frame from a plurality of pre-configured sound animation frames for representing the sound volume; and displaying a sound interface control in a graphical user interface, and controlling the target animation frame to be rendered and played in the sound interface control, so as to prompt the change in sound volume of the controlled virtual character in the process of executing the first game behavior.

### CROSS-REFERENCE TO RELATED APPLICATIONS

The present disclosure is a U.S. National Stage of International Application No. PCT/CN2023/095879, filed on May 23, 2023, which claims priority to Chinese patent application number 202211590835.8, filed on Dec. 12, 2022, both of which are incorporated herein in their entireties for all purposes.

### TECHNICAL FIELD

The present disclosure relates to the field of computers, and in particular to interactive animation processing method and device, a storage medium and an electronic device.

### BACKGROUND

At present, the existing solutions for visualizing the volume of sound that are common in Internet products are: first capture the audio signal input by a microphone or an audio file, then generate a data group with frequency and level information based on the audio spectrum, and then convert the data group into a visual pattern, which can change with the current pitch and frequency of the audio. However, this method is only applicable to audio with a relatively single signal source, such as voice input and music playback. When used in game development, its calculation amount becomes very complicated, resulting in low efficiency when visualizing audio.

No effective solution has been proposed for the above problems.

It should be noted that the information disclosed in the above background technology section is only used to enhance the understanding of the background of the present disclosure, and therefore may include information that does not constitute related technology known to those skilled in the art.

### SUMMARY

According to the present disclosure, there is provided a method for processing interactive animation, providing a graphical user interface through a terminal device, content displayed in the graphical user interface comprising at least part of a game scene, the game scene including a controlled virtual character, and the method including: in response to the controlled virtual character performing a first game behavior in the game scene, acquiring a first sound value of the controlled virtual character before the first game behavior is performed and a second sound value of the controlled virtual character after the first game behavior is performed, where the first sound value and the second sound value are pre-configured game parameters for characterizing sound states of the controlled virtual character before and after the first game behavior is performed; according to the first sound value and the second sound value, determining a target frame animation from a pre-configured multi-frame sound animation for characterizing sound volume, where the multi-frame sound animation includes all animation frames from a first animation frame corresponding to a minimum sound value to a second animation frame corresponding to a maximum sound value; and prompting a change in the sound volume of the controlled virtual character during execution of the first game behavior by displaying a sound interface control in the graphical user interface and controlling to render and play the target frame animation in the sound interface control.

According to the present disclosure, there is further provided a non-transitory storage medium, where a computer program is stored in the non-transitory storage medium, and the computer program is configured to execute the method for processing interactive animation in any one of the above items when the computer program is executed.

According to the present disclosure, there is further provided an electronic device, including a memory and a processor, where the memory stores a computer program, and the processor is configured to execute the computer program to execute the method for processing interactive animation according to any one of the above items.

### BRIEF DESCRIPTION OF THE DRAWINGS

The drawings described herein are used to provide further understanding of the present disclosure and constitute a part of the present application. The schematic embodiments of the present disclosure and their descriptions are used to explain the present disclosure and do not constitute improper limitations on the present disclosure. In the drawings:

FIG. 1 is a hardware structure block diagram of a mobile terminal of an interactive animation processing method according to one of the embodiments of the present disclosure;

FIG. 2 is a flow chart of an interactive animation processing method according to one of the embodiments of the present disclosure;

FIG. 3 is a schematic diagram of an optional target transverse coordinate system according to one of the embodiments of the present disclosure;

FIG. 4 is a schematic diagram of an optional target longitudinal coordinate system according to one of the embodiments of the present disclosure;

FIG. 5 is a schematic diagram of an optional second transverse texture coordinate system according to one of the embodiments of the present disclosure;

FIG. 6 is a schematic diagram of an optional third transverse texture coordinate system according to one of the embodiments of the present disclosure;

FIG. 7 is an optional preset mask map according to one of the embodiments of the present disclosure;

FIG. 8 is a structural block diagram of a device according to one of the embodiments of the present disclosure;

FIG. 9 is a schematic diagram of an electronic device according to one of the embodiments of the present disclosure.

### DETAILED DESCRIPTION

In order to enable people in the technical field to better understand the scheme of the present disclosure, the technical scheme in the embodiment of the present disclosure will be clearly and completely described below in conjunction with the drawings in the embodiment of the present disclosure. Obviously, the described embodiment is only a part of the embodiment of the present disclosure, not all of the embodiments. Based on the embodiments in the present disclosure, all other embodiments obtained by those skilled in the art without creative work should fall within the scope of protection of the present disclosure.

It should be noted that the terms “first”, “second”, etc. in the description and claims of the present disclosure and the above-mentioned drawings are used to distinguish similar objects, and are not necessarily used to describe a specific order or sequence. It should be understood that the data used in this way can be interchangeable where appropriate, so that the embodiments of the present disclosure described here can be implemented in an order other than those illustrated or described here. In addition, the terms “including” and “having” and any of their variations are intended to cover non-exclusive inclusions. For example, a process, a method, a system, a product or a device that includes a series of steps or units is not necessarily limited to those steps or units clearly listed, but may include other steps or units that are not clearly listed or inherent to the process, the method, the product or the device.

According to one embodiment of the present disclosure, an embodiment of an interactive animation processing method is provided. It should be noted that the steps shown in the flowchart of the attached figure can be executed in a computer system such as a set of computer executable instructions, and although the logical order is shown in the flowchart, in some cases, the steps shown or described can be executed in a different order than here.

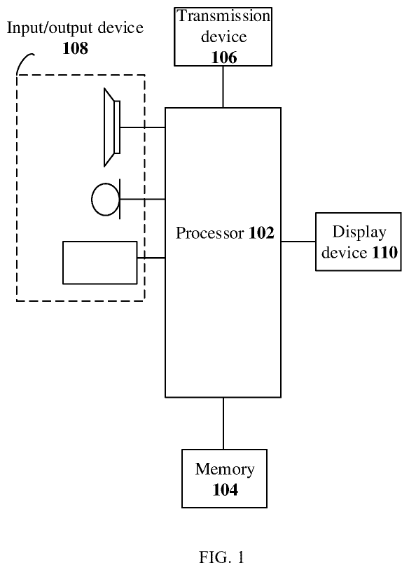

The method embodiment can be executed in a mobile terminal, a computer terminal or a similar computing device. Taking running on a mobile terminal as an example, the mobile terminal can be a smart phone (such as an Android phone, an iOS phone, etc.), a tablet computer, a PDA, a mobile Internet device (referred to as MID), a PAD, a game console and other terminal devices. FIG. 1 is a hardware structure block diagram of a mobile terminal of an interactive animation processing method of an embodiment of the present disclosure. As shown in FIG. 1, the mobile terminal may include one or more (only one is shown in FIG. 1) processors 102 (the processor 102 may include but is not limited to a central processing unit (CPU), a graphics processing unit (GPU), a digital signal processing (DSP) chip, a microprocessor (MCU), a programmable logic device (FPGA), a neural network processor (NPU), a tensor processor (TPU), an artificial intelligence (AI) type processor, etc.) and a memory 104 for storing data. Alternatively, the mobile terminal may further include a transmission device 106, an input/output device 108, and a display device 110 for communication functions. It will be understood by those skilled in the art that the structure shown in FIG. 1 is for illustration only and does not limit the structure of the mobile terminal. For example, the mobile terminal may also include more or fewer components than those shown in FIG. 1, or have a configuration different from that shown in FIG. 1.

The memory 104 may be configured to store computer programs, for example, software programs and modules of application software, such as computer programs corresponding to the processing method of interactive animation in the embodiment of the present disclosure. The processor 102 executes various functional applications and data processing (that is, implements the processing method of the interactive animation) by running the computer programs stored in the memory 104. The memory 104 may include a high-speed random access memory, and may also include a non-volatile memory, such as one or more magnetic storage devices, flash memories, or other non-volatile solid-state memories. In some embodiments, the memory 104 may further include a memory remotely arranged relative to the processor 102, and such remote memory may be connected to the mobile terminal via a network. Examples of the above-mentioned network include, but are not limited to, the Internet, an intranet, a local area network, a mobile communication network, and combinations thereof.

The transmission device 106 is configured to receive or send data via a network. The specific example of the above network may include a wireless network provided by a communication provider of the mobile terminal. In one example, the transmission device 106 includes a network adapter (Network Interface Controller, abbreviated as NIC), which can be connected to other network devices through a base station so as to communicate with the Internet. In one example, the transmission device 106 can be a radio frequency (abbreviated as RF) module, which is configured to communicate with the Internet wirelessly.

The input in the input and output device 108 can come from multiple human interface devices (abbreviated as HID), e.g., keyboard and mouse, game controller, other dedicated game controllers (such as: steering wheel, fishing rod, dance mat, remote control, etc.). In addition to providing input functions, some human interface devices can also provide output functions, such as: force feedback and vibration of game controllers, audio output of controllers, etc.

The display device 110 can be, for example, a head-up display (HUD), a touch screen liquid crystal display (LCD) and a touch display (also known as a “touch screen” or “touch display”). The LCD display enables the user to interact with the user interface of the mobile terminal. In some embodiments, the mobile terminal has a graphical user interface (GUI), and the user can interact with the GUI by touching the touch-sensitive surface with fingers and/or gestures. The human-computer interaction functions here optionally include the following interactions: creating web pages, drawing, word processing, making electronic documents, games, video conferencing, instant messaging, sending and receiving emails, call interfaces, playing digital videos, playing digital music and/or web browsing, etc. The executable instructions for performing the above human-computer interaction functions are configured/stored in a computer program product executable by one or more processors or a readable storage medium.

The interactive animation processing method in an embodiment of the present disclosure can be run on a local terminal device or a server. When the interactive animation processing method is run on a server, the method can be implemented and executed based on a cloud interaction system, where the cloud interaction system includes a server and a client device.

In an embodiment, various cloud applications can be run under the cloud interaction system, such as cloud games. Taking cloud games as an example, the cloud games refer to a game method based on cloud computing. In the operation mode of cloud games, the execution entity of the game program and the rendering entity of the game screen are separated. The storage and execution of the interactive animation processing method are completed on the cloud game server, and the role of the client device is receiving and sending data and rendering the game screen. For example, the client device can be a display device with data transmission function close to the user side, such as a mobile terminal, a TV, a computer, a handheld computer, etc.; but the cloud game server in the cloud is used for information processing. When playing the game, the player operates the client device to send an operation instruction to the cloud game server. The cloud game server runs the game according to the operation instruction, encodes and compresses the game screen and other data, and returns it to the client device through the network. Finally, the client device decodes and outputs the game screen.

In an embodiment, taking the game as an example, the local terminal device stores the game program and is configured to present the game screen. The local terminal device is configured to interact with the player through a graphical user interface, that is, the game program is downloaded and installed and run by an electronic device in a conventional manner. The local terminal device can provide the graphical user interface to the player in a variety of ways. For example, it can be rendered and displayed on the display screen of the terminal, or provided to the player through holographic projection. For example, the local terminal device may include a display screen and a processor. The display screen is configured to present a graphical user interface, the graphical user interface includes a game screen, and the processor is configured to run the game, generate a graphical user interface, and control the display of the graphical user interface on the display screen.

The methods involved in the related art are only applicable to audio with a relatively single signal source, such as voice input and music playback. When used in game development, the amount of calculation becomes very complicated. For example, the real-time sound heard by the player in the game is not from a single sound source, but is obtained by complex environmental sounds, collision sounds generated by player actions, and even global sound effects through complex weight calculations. If the relevant scheme is used to monitor the noise in the game at this time, there will be the following problems:

1. The amount of calculation is huge. From the time the player makes an action to the time he sees the prompt that his own noise has increased, he has to go through a lengthy linear process of “making an action—calculating audio—playing various audios-capturing synthesized audio—converting sound signals into visual graphics—graphic output”, which not only wastes a lot of development manpower, but also leads to waste of game performance and even lag.

2. When the noise generated by the player's actions in a specific environment is fed back in real time, the player's behavior is the determining factor, while the uncontrollable ambient sound and global music are regarded as interference items. In this case, if the methods in the related art are used, the effect will become more difficult to control.

First, the technical Terminologies or technical terms appearing in the embodiments of the present disclosure are explained as follows:

Shader language: It is a language that can write the screen content displayed on the model through specific code, which can also be referred to as Shader.

Editor: It refers to a software that allows designers to create interfaces and animation segments of interface components, which can also be referred to as BootstrspUI editor, abbreviated as UI editor. The shader and the UI editor can be imported into the game engine as resources, and the program can monitor the behavior of players in the game, and can also call various resources to play and display in the game.

Texture coordinate system: It can also be referred to as UV map. UV refers to the abbreviation of UV texture mapping coordinates. It is similar to the X, Y, and Z axes of the spatial model. It defines the position information of each point on the picture.

Time parameter: The time parameter here is a parameter that comes with the programming language. It can automatically read the real-time time inside the engine and output it to the shader as a variable to participate in the calculation. The significance of introducing the time parameter here is to turn the static shader picture into a dynamic picture that changes over time.

Expression node: It refers to a node that can make a texture coordinate system do circular translation and scrolling along a certain direction. Two texture coordinate systems with different aspect ratios can be inserted into two expression nodes respectively, and they can be translated in different directions and speeds, so that the two moving coordinate systems can turn the static noise map into a dynamic one, and multiply the two noise maps with different speeds to get a more random rolling number set.

Noise map: It is a black and white map with irregular colors scattered. Sampling it can get a set of irregularly changing 0-1 numbers. Therefore, a static noise map can be loaded as a calculation material for generating rolling random values.

Mask map: It is used to mask the image. The image can be cropped into the required form through the mask. Take the transparency mask as an example to illustrate. Assume that black represents 0 and white represents 1. In transparency, 0 represents complete transparency and 1 represents complete opacity. Therefore, a picture with white in the middle and black around can be loaded as a transparency mask to multiply with the noise pattern. According to the rule of 1*n=n, 0*n=0, the black part of the mask will make the surrounding of the multiplication result black, while the white part in the middle will completely retain the appearance of the texture. Then this calculation result is output to the final transparency channel of the shader, and a pattern with transparent black parts and opaque white parts can be obtained.

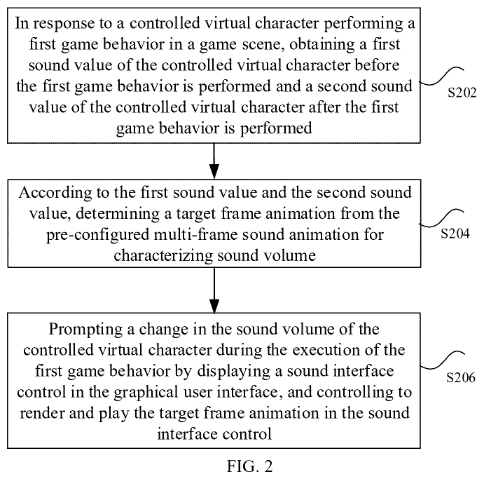

In a possible implementation, the embodiment of the present disclosure provides an interactive animation processing method, providing a graphical user interface through a terminal device, where the terminal device can be the local terminal device mentioned above, or the client device in the cloud interaction system mentioned above. FIG. 2 is a flow chart of an interactive animation processing method according to an embodiment of the present disclosure. A graphical user interface is provided through a terminal device, and the content displayed by the graphical user interface includes a touch area. As shown in FIG. 2, the method includes the following steps:

Step S202, in response to a controlled virtual character performing a first game behavior in a game scene, obtaining a first sound value of the controlled virtual character before the first game behavior is performed and a second sound value of the controlled virtual character after the first game behavior is performed, wherein the first sound value and the second sound value are pre-configured game parameters for characterizing the sound states of the controlled virtual character before and after the first game behavior is performed.

The above-mentioned game scene may include a virtual human, a virtual animal, etc. in the game. Alternatively, the virtual human and the virtual animal may be in a non-static state.

The above-mentioned controlled virtual character may be a virtual human, a virtual animal, etc. in the game scene. Alternatively, the virtual human and the virtual animal may make actions, for example, the virtual human fighting in the game scene, the virtual human driving a vehicle in the game scene, the virtual animal talking in the game scene, etc.

The above-mentioned first game behavior may be a state of making an action. Alternatively, the action may include but is not limited to fighting, running, walking, talking, etc.

The above-mentioned game parameters may be specific values. Alternatively, the game parameters may include running speed, swimming speed, etc.

In an embodiment, the real-time state of the controlled virtual character in the game scene can be obtained by monitoring the game scene, where the real-time state of the controlled virtual character can be the real-time action of the controlled virtual character. Alternatively, the first sound value of the controlled virtual character before executing the first game behavior and the second sound value after executing the first game behavior can be pre-set. The first sound values corresponding to different controlled virtual characters are different, and the second sound values corresponding to different first game behaviors executed by different controlled virtual objects are different. Further, the second sound values generated when the same controlled virtual object executes different first game behaviors are also different. Alternatively, the game scene can be monitored by a corresponding program, and the behavior of the controlled virtual character can be supervised, so as to obtain the role type of the controlled virtual character and the type of the first game behavior specifically executed, and determine the corresponding data from the pre-set first sound value and second sound value, so as to obtain the game parameters of the sound state of the controlled virtual object before executing the first game behavior and the game state parameters after executing the first game behavior. Alternatively, the parameters can be used to visualize the audio data.

Step S204, according to the first sound value and the second sound value, determining a target frame animation from the pre-configured multi-frame sound animation for characterizing sound volume, where the multi-frame sound animation includes all animation frames from a first animation frame corresponding to a minimum sound value to a second animation frame corresponding to a maximum sound value.

The above-mentioned multi-frame sound animation can be configured to display the action behaviors corresponding to the different second sound values emitted when the controlled virtual object performs different first game behaviors. Alternatively, the multi-frame sound animation can be represented by a changing sound waveform.

The above-mentioned target frame animation can be a sound animation corresponding to the second sound value emitted by the controlled virtual object in the current period in the multi-frame sound animation.

In an embodiment, after obtaining the second sound value, sound waves with different lengths can be set according to the volume of the second sound value, and the change of the second sound value can be represented by the change of the sound wave. Alternatively, since the second sound value of the controlled virtual object may change, the frequency and amplitude of the sound wave will also change accordingly. For example, according to the current state of the controlled virtual object, it is determined that the first game behavior performed by the controlled virtual object is running, and the second sound value is 42. In the next second, according to the current state of the controlled virtual object, it is determined that the first game behavior performed by the controlled virtual object is crouching, and the second sound value is 25. Therefore, the frequency and amplitude of the sound wave representing the second sound value will also change accordingly, that is, the changing speed of the sound wave and the length of the sound wave will change. Or, according to the second sound value of the controlled virtual object, it is determined that the first game behavior performed by the controlled virtual object is jogging, and the second sound value is 42, but at the next second, the controlled virtual object speeds up the running speed, so the changing speed of the sound wave and the length of the sound wave will change. Alternatively, a parameter can be set to interfere with the sound wave so that the waveform changes with the actual sound source volume.

In another embodiment, there is a need for a solution in the game development process to effectively display the volume generated in the game scene in real time, so as to prompt the player. Therefore, there is no need to monitor the audio in the game, and the audio visualization operation can be completed only according to the second sound value of the controlled virtual object in the game scene.

Step S206, prompting a change in the sound volume of the controlled virtual character during the execution of the first game behavior by displaying a sound interface control in the graphical user interface, and controlling to render and play the target frame animation in the sound interface control.

The above-mentioned graphical user interface can be a display interface of the game, where the graphical user interface can include a sound interface control, and the sound interface control can be configured to express the volume generated when the controlled virtual character performs the first game behavior in an animated form.

In an embodiment, different sound source volumes generated when the controlled virtual character performs the first game behaviors can be pre-set. That is, a fixed sound source volume can be set for each first game behavior, where the sound source volume indicates the volume of the sound of the controlled virtual character during the execution of the first game behavior. For example, the sound source volume of sneaking is set to 42, and the sound source volume of running is set to 65, but it is not limited to this.

Table 1 below is a state information table of a controlled virtual object according to an embodiment of the present disclosure. As shown in Table 1, the first game behavior obtained can be numbered, for example, sneaking is marked as 1, running is marked as 2, driving is marked as 3, crouching is marked as 4, skills are marked as 5, bows and arrows are marked as 6, combat is marked as 7, and flying over the eaves and walls is marked as 8. At the same time, the sound source volume corresponding to each first game behavior can be preset. For example, the sound source volume of sneaking is set to 42, the sound source volume of running is set to 65, the sound source volume of driving is set to 70, the sound source volume of crouching is set to 25, the sound source volume of skills is set to 69, the sound source volume of bows and arrows is set to 40, the sound source volume of combat is set to 75, and the sound source volume of flying over the eaves and walls is set to 80. Alternatively, when the first game behavior executed by the controlled virtual object is detected, the sound source volume corresponding to the first game behavior can be determined according to the preset first game behavior type, and the second sound value when the controlled virtual character executes the first game behavior can be determined according to the sound source volume.

In an embodiment, the sound source volume can be corrected by setting an attenuation function, where the attenuation function can be a corresponding mathematical formula, which can be used to correct the data to make the data more realistic. For example, the sound source volume corresponding to sneaking under ideal conditions is 42, but in fact, during sneaking, the character's physical strength changes and the breathing is uneven, which will cause the sound source volume to be unstable during sneaking. Alternatively, the sound source volumes marked as 1, 2, 3, 4, 5, 6, 7, and 8 can be corrected respectively through the attenuation function, so that the sound source volume can be closer to reality. Alternatively, since the amplitudes of changes of different sound source types are different, different attenuation functions can be set for different sound source volumes.

TABLE 1

| First game | | Sound source | Attenuation |
|---|---|---|---|
| behavior | Remark | volume | function |
| 1 | Sneaking | 42 | 1 |
| 2 | Running | 65 | 2 |
| 3 | Driving | 70 | 3 |
| 4 | Crouching | 25 | 4 |
| 5 | Skills | 69 | 5 |
| 6 | Bows and arrows | 40 | 6 |
| 7 | Combat | 75 | 7 |
| 8 | Flying over the | 80 | 8 |
| | eaves and walls | | |

In at least some embodiments of the present disclosure, in response to a controlled virtual character performing a first game behavior in a game scene, a first sound value of the controlled virtual character before performing the first game behavior and a second sound value after performing the first game behavior are obtained. The first sound value and the second sound value are pre-configured game parameters for characterizing the sound states of the controlled virtual character before and after the first game behavior is performed. According to the first sound value and the second sound value, a target frame animation is determined from a pre-configured multi-frame sound animation for characterizing the sound volume, where the multi-frame sound animation includes all animation frames from a first animation frame corresponding to the minimum sound value to a second animation frame corresponding to the maximum sound value. A sound interface control is displayed in a graphical user interface, and the rendering and playback of the target frame animation in the sound interface control is controlled to prompt the change in the sound volume of the controlled virtual character during the execution of the first game behavior. It is easy to notice that game parameters for characterizing the sound states of the controlled virtual character before and after the execution of the first game behavior, that is, the first sound value and the second sound value, can be pre-configured, and a multi-frame sound animation for representing the sound volume can be pre-configured at the same time. The target frame animation is determined based on the first sound value and the second sound value, so that the multi-frame sound animation can be adjusted, and real-time acquisition of audio data in the game can be avoided. Only by obtaining the game parameters of the sound states of the controlled virtual character before and after the execution of the first game behavior, the simulated audio can be obtained, thereby realizing the visualization operation of the audio, and further solving the technical problem of low efficiency in the visualization operation of the audio in the related art.

Alternatively, displaying a sound interface control in a graphical user interface, and controlling rendering and playing of a target frame animation in the sound interface control includes obtaining the target frame animation by matching the multi-frame sound animation according to a first sound value and a second sound value, and taking a first animation frame corresponding to the first sound value as an initial frame of the target frame animation, and taking a second animation frame corresponding to the second sound value as a last frame of the target frame animation; and controlling the rendering and playing of the target frame animation in the sound interface control.

The first animation frame mentioned above may be an animation frame corresponding to the first sound value. After the first sound value is determined, an animation frame corresponding to the first sound value may be determined from the pre-set multi-frame sound animation, and the animation frame corresponding to the first sound value may be determined as the initial frame of the target frame animation.

The second animation frame mentioned above may be an animation frame corresponding to the second sound value. After the second sound value is determined, an animation frame corresponding to the second sound value may be determined from the pre-set multi-frame sound animation, and the animation frame corresponding to the second sound value may be determined as the last frame of the target frame animation.

In an embodiment, the first sound value and the second sound value may be matched with the pre-set multi-frame sound animation. The animation frame corresponding to the first sound value may be determined as the initial frame of the target frame animation, and the animation frame corresponding to the second sound value may be determined as the last frame of the target frame animation, thereby obtaining the target frame animation. Alternatively, after the target frame animation is determined, the target animation frame may be displayed through the sound interface control on the game interface, thereby realizing the visualization operation of the audio data.

Alternatively, according to the first sound value and the second sound value, determining a first sound animation and a second sound animation from the multi-frame sound animation respectively includes obtaining the first sound animation and the second sound animation by mapping the first sound value and the second sound value to the multi-frame sound animation respectively.

The above-mentioned first sound animation may be a sound animation corresponding to the first sound value.

The above-mentioned second sound animation may be a sound animation corresponding to the second sound value.

In an embodiment, after obtaining the first sound value and the second sound value, the first sound value and the second sound value may correspond to the preset multi-frame sound animation to achieve one-to-one matching. Alternatively, after corresponding the first sound value and the second sound value to the preset multi-frame sound animation, the sound animation corresponding to the first sound value may be determined as the first sound animation, and the sound animation corresponding to the second sound value may be determined as the second sound animation. Alternatively, the first sound animation and the second sound animation may be configured to determine the target frame animation.

Alternatively, displaying a sound interface control in a graphical user interface, and controlling the rendering and playing of the target frame animation in the sound interface control includes rendering the preset display area in the sound interface control through a shader node so that the sound interface control plays the target frame animation.

The above-mentioned shading node can be configured to play and display the target frame animation on the game interface. Alternatively, after obtaining the target frame animation, the target frame animation can be rendered and played using the shader node, thereby realizing the visualization operation of the audio data.

Alternatively, the method further includes obtaining multiple game behaviors pre-set for the controlled virtual character; configuring game parameters of the multiple game behaviors according to the sound states and preset volume ranges corresponding to the multiple game behaviors, where the game parameters are configured to represent the sound states of the multiple game behaviors by sound values.

The above-mentioned multiple game behaviors can be pre-set by those skilled in the art. For example, the multiple game behaviors can include but are not limited to running, sneaking, and swimming.

The sound states corresponding to the above-mentioned multiple game behaviors may include but are not limited to the volumes of the sound, that is, the sound source volumes.

The above-mentioned game parameters can be determined according to the state of the controlled virtual object in the game and the sound source volume. Alternatively, the amplitude of the sound wave can be determined according to the game parameters. Alternatively, the game parameter can be a numerical variable configured to adjust the amplitude of the sound wave in the multi-frame sound animation, so that the sound animation displayed is more realistic. Furthermore, the entire interactive animation processing method can be encapsulated, and an interface can be set externally, and the user can input the game parameter into the interface.

In an embodiment, after obtaining the game parameters and the sound source volume, since the game parameters and the sound source volume may change in real time, it is necessary to set a game parameter to adjust the sound wave so that the sound wave changes, thereby adjusting the target frame animation.

In another embodiment, the sound source volume is generated by the current state of the controlled virtual object in the game. The behavior of the controlled virtual object can be defined as different states in the game, and each state has a corresponding sound source volume. The state change of the controlled virtual object will cause the current actual sound source volume to change. Therefore, it is necessary to set a game parameter to interfere with the sound wave, so as to adjust the target frame animation.

Alternatively, the method further includes, in response to the controlled virtual character completing the first game behavior in the game scene, obtaining an attenuation function corresponding to the first game behavior; obtaining a third sound value by attenuating the second sound value based on the attenuation function; determining a preset frame animation from a pre-configured multi-frame sound animation for characterizing the sound volume according to the second sound value and the third sound value; and controlling the rendering and playing of the preset frame animation in the sound interface control.

In an embodiment, the first game behavior may be a game behavior with a relatively short duration such as activating a skill. After the first game behavior ends, in order to make the first game behavior more realistic, the attenuation function corresponding to the first game behavior may be obtained, and the second sound value corresponding to the first game behavior may be attenuated by the attenuation function to obtain the first sound value for transition, so as to transition the end of the first game behavior by the second sound value.

In another embodiment, when the controlled virtual object performs the first game behavior, since the state of the controlled virtual object may change, the game parameters may be set to interfere with the sound waves of the preset frame animation, thereby adjusting the preset frame animation. For example, some attenuation formulas can be used to gradually reduce the sound source volume of the second sound value to simulate the attenuation of the actual sound volume. That is, the sound source volumes are attenuated, and the sound source volumes after attenuation calculation are put together to calculate the final sound source volume according to different weights. Different sound source volumes can correspond to different attenuation functions.

For example, when the running speed of the controlled virtual object is detected to change, the running speed at that moment can be input into the attenuation function to obtain the game parameters, and the sound source volume for representing running can be adjusted by the game parameters, so that the displayed preset frame animation can be more accurate.

For example, a multi-frame sound animation is a 100-frame animation from quiet to noisy. Here, the waveform adjusted by the game parameters can directly correspond to the animation performance of the corresponding frame. For example, if the actual sound source volume changes from 20 to 50, the animation from the 20th frame to the 50th frame is played.

Alternatively, the method further includes constructing a texture coordinate system; obtaining an original transverse texture coordinate system and an original longitudinal texture coordinate system by performing computational processing on the texture coordinate system; obtaining a target transverse texture coordinate system by adding a noise variable to the original transverse texture coordinate system; obtaining a target longitudinal texture coordinate system by processing the original longitudinal texture coordinate system based on a preset absolute value; and generating a multi-frame sound animation based on the target transverse texture coordinate system and the target longitudinal texture coordinate system.

The above-mentioned texture coordinate system may be a coordinate system on a specified area. The coordinate system may have multiple vertices, each vertex has a corresponding color, and alternatively, the coordinate range of the texture coordinate system may be 0 to 1.

The above-mentioned original transverse texture coordinate system and original longitudinal texture coordinate system may be separated from the texture coordinate system. Alternatively, the coordinate range of the entire texture coordinate system may be expanded, where the expansion multiple is not limited. For example, the coordinate system range is expanded by two times, and then a minus 1 operation is performed, thereby adjusting the range of the texture coordinate system from 0 to 1 to negative 1 to positive 1.

The above-mentioned target transverse texture coordinate system can be obtained from the original transverse texture coordinate system. Alternatively, the required part can be cut out from the original transverse texture coordinate and determined as the target transverse texture coordinate. FIG. 3 is a schematic diagram of an alternative target transverse coordinate system according to an embodiment of the present disclosure. As shown in FIG. 3, since the range of the coordinate system in the original transverse texture coordinate is small, the entire coordinate system can be expanded. The multiple of expansion can be set by the user. Taking the expansion of 20 times as an example, the entire coordinate system can be expanded by 20 times, and the range of the target transverse coordinate system is changed to negative 20 to positive 20.

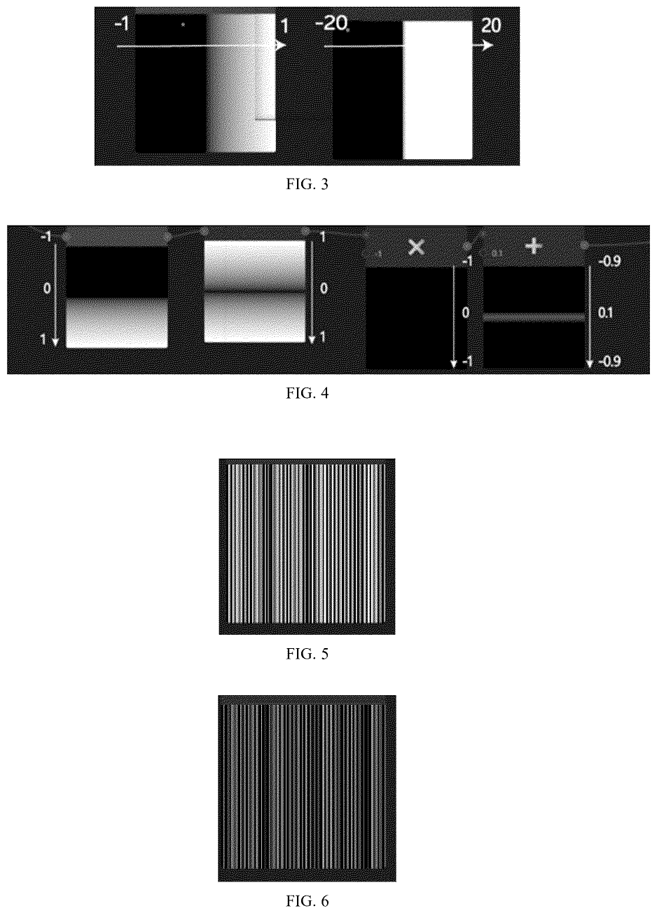

The above-mentioned target longitudinal texture coordinate system can be obtained from the original longitudinal texture coordinate system. Alternatively, the required part can be cut out from the original longitudinal texture coordinate and determined as the target longitudinal texture coordinate. FIG. 4 is a schematic diagram of an alternative target longitudinal coordinate system according to an embodiment of the present disclosure. As shown in FIG. 4, the user can adjust the range of the target longitudinal texture coordinate system by setting a preset absolute value. For example, the absolute value of the original longitudinal coordinate system is taken, the absolute value is multiplied by negative 1, and then 0.1 is added to change the range of the target longitudinal coordinate system.

In an embodiment, after determining the target transverse texture coordinate system and the target longitudinal texture coordinate system, a waveform corresponding to the sound source volume can be generated through the target transverse texture coordinate system and the target longitudinal texture coordinate system, thereby obtaining a multi-frame sound animation.

Alternatively, obtaining the target transverse texture coordinate system by adding a noise variable to the original transverse texture coordinate system includes obtaining a first transverse texture coordinate system by processing the original transverse texture coordinate system based on the time variable, where the first transverse texture coordinate system changes based on the time variable; obtaining a second transverse texture coordinate system by processing the first transverse texture coordinate system based on a periodic function, where the second transverse texture coordinate system changes periodically based on the time variable; obtaining a third transverse texture coordinate system by processing the second transverse texture coordinate system based on the noise variable; and obtaining the target transverse texture coordinate system by processing the third transverse texture coordinate system based on a random number set.

The above-mentioned time variable can be a time parameter, which can obtain the time running in the game in real time and can change continuously. The time parameter can be set by the user. Alternatively, a dynamic waveform that changes continuously with time can be generated by introducing the time variable.

The first transverse texture coordinate system can be obtained by processing the original transverse texture coordinate system through the time variable.

The periodic function can be a sine function.

The second transverse texture coordinate system can be obtained by processing the first transverse texture coordinate system through the sine function. FIG. 5 is a schematic diagram of an alternative second transverse texture coordinate system according to an embodiment of the present disclosure. As shown in FIG. 5, the calculation result in the first transverse texture coordinate system can be brought into the sine function to obtain the second transverse texture coordinate system.

The third transverse texture coordinate system can be obtained by processing the second transverse texture coordinate system through the noise variable, where the noise variable can be a constant parameter, which can be set by the user. The magnitude of the noise variable value can be adjusted by the user in the editor panel after the shader is encapsulated. FIG. 6 is a schematic diagram of an alternative third transverse texture coordinate system according to an embodiment of the present disclosure. As shown in FIG. 6, the difference amplitude of the sine function can be controlled by multiplying the noise variable with the sine function.

The random number set can be used to stretch the third transverse texture coordinate system to obtain the target transverse coordinate system.

In an embodiment, after obtaining the original transverse texture coordinate system, the user can set a time variable to process the original transverse texture coordinate system, thereby obtaining a first transverse texture coordinate system. After obtaining the first transverse texture coordinate system, a sine function can be introduced to process the first transverse texture coordinate system, thereby obtaining a second transverse texture coordinate system. Alternatively, on this basis, a noise variable can be set to adjust the second transverse texture coordinate system, thereby obtaining a third transverse texture coordinate system. Alternatively, by introducing a random number set to process the third transverse texture coordinate system, a target transverse texture coordinate system can be obtained, where the target transverse texture coordinate system can be configured to generate a multi-frame sound animation.

Alternatively, generating a multi-frame sound animation based on a target transverse coordinate texture and a target longitudinal coordinate texture includes obtaining a target texture coordinate system by adding the target longitudinal texture coordinate system and the target transverse texture coordinate system; and generating a multi-frame sound animation based on the target texture coordinate system.

In an embodiment, after obtaining the target transverse texture coordinate system and the target longitudinal texture coordinate system, the target transverse texture coordinate system and the target longitudinal texture coordinate system can be added to obtain the target texture coordinate system. Alternatively, the target texture coordinate system can be configured to generate the multi-frame sound animation.

Alternatively, generating the multi-frame sound animation based on the target texture coordinate system includes obtaining a smooth texture coordinate system by smoothing the target texture coordinate system using a smooth step function; obtaining a mask texture coordinate system by merging the preset mask map and the smooth texture coordinate system, where the preset area of the preset mask map is an opaque area, and the other areas of the preset mask map except the preset area are transparent areas; obtaining the target texture coordinate system by adjusting the mask texture coordinate system based on the transparency variable and the color variable, where the transparency variable is configured to adjust the transparency of the target texture coordinate system, and the color variable is configured to adjust the color of the target texture coordinate system.

The smooth step function (Smoothstep) can be configured to smooth the target texture coordinate system, where the Smoothstep function can be configured to make a specified range present a smoother transition. The specified range can be set by the user. Alternatively, the Smoothstep function can be configured to prevent the pixel boundary of the generated target coordinate system from generating jagged edges due to sudden transparency changes, thereby making the target coordinate system visually smoother.

The smooth texture coordinate system can be obtained by smoothing the target texture coordinate system by the smooth step function.

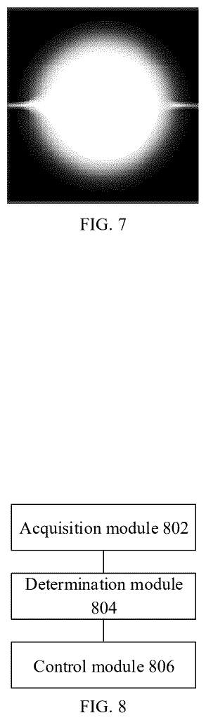

The preset mask map can be configured to modify the outer contour of the smooth texture coordinate system and add color attributes. FIG. 7 is an alternative preset mask map according to an embodiment of the present disclosure. As shown in FIG. 7, the preset mask map can be a white spherical mapping node.

The mask texture coordinate system can be configured to display multi-frame sound animation.

The preset area can be the area where the preset mask map is located.

The transparency variable and the color variable can be set by the user. For example, the transparency variable is set from 0 to 1, and the color variable is set to a four-digit parameter to control the color change.

In an embodiment, after obtaining the target texture coordinate system, the target texture coordinate system can be smoothed using the Smoothstep function to obtain a smooth texture coordinate system. Alternatively, the user can set a preset mask map, and merge the preset mask map with the smooth texture coordinate system to modify the smooth texture coordinate system, and add a color attribute to the smooth texture coordinate system to obtain a mask texture coordinate system. Alternatively, the preset area where the preset mask map is located in the smooth texture coordinate system is an opaque area, and other areas except the preset area are transparent areas. Alternatively, the transparency variable and the color variable can also be set to adjust the color and transparency of the mask texture coordinate system to obtain the target texture coordinate system.

Alternatively, the method further includes obtaining a first texture coordinate system by processing the texture coordinate system using a first preset parameter; obtaining a second texture coordinate system by processing the texture coordinate system using a second preset parameter, where the second preset parameter is different from the first preset parameter; obtaining a first number set corresponding to the first texture coordinate system and a second number set corresponding to the second texture coordinate system by processing the first texture coordinate system and the second texture coordinate system respectively according to the time variable and the preset time rolling parameter; and obtaining a random number set by multiplying the first number set and the second number set.

The first preset parameter can be set by the user, where the first preset parameter can be used to stretch the texture coordinate system.

The first texture coordinate system can be obtained by stretching the texture coordinate system.

The second preset parameter can be set by the user. The second preset parameter can be used to stretch the texture coordinate system. Alternatively, the second preset parameter is different from the first preset parameter.

The second texture coordinate system can be obtained by stretching the texture coordinate system.

The preset time rolling parameter can be configured to adjust the direction and speed of the first texture coordinate system and the second texture coordinate system rolling over time according to the time variable.

The first number set can be obtained by processing the first texture coordinate system by the time variable and the preset time rolling parameter.

The second number set can be obtained by processing the second texture coordinate system by the time variable and the preset time rolling parameter.

In an embodiment, the user can set a first preset parameter and a second preset parameter, which are used to respectively stretch the texture coordinate system, so as to obtain the first texture coordinate system and the second texture coordinate system. Further, the first texture coordinate system and the second texture coordinate system obtained after the stretching process, which change with time, are mapped to the inserted noise map to obtain two random number sets with different change rates, that is, a first number set and a second number set. The noise map can be a set of number. That is, the first texture coordinate system can be processed by the time variable and the preset time rolling parameter to obtain the first number set, and the second texture coordinate system can be processed by the time variable and the preset time rolling parameter to obtain the second number set. Further, the first number set and the second number set can be multiplied to obtain the random number set. Alternatively, the random number set can be configured to stretch the third transverse texture coordinate system to obtain the target transverse coordinate system.

Through the description of the above implementation, those skilled in the art can clearly understand that the method according to the above embodiment can be implemented by means of software plus the necessary general hardware platform, and of course by hardware, but in many cases the former is a better implementation. Based on this understanding, the technical solution of the present disclosure essentially or in part contributing to the related art may be embodied in the form of a software product, which is stored in a storage medium (such as ROM/RAM, disk, CD), including several instructions to enable a terminal device (which can be a mobile phone, computer, server, or network device, etc.) to execute the methods of respective embodiments of the present disclosure.

In this embodiment, a device is also provided, which is configured to implement the above embodiment and preferred implementation, the description has been made and will not be repeated. As used below, the terms “unit” and “module” can implement a combination of software and/or hardware of a predetermined function. Although the device described in the following embodiments is preferably implemented in software, the implementation of hardware, or a combination of software and hardware, is also possible and conceived.

FIG. 8 is a structural block diagram of a device according to an embodiment of the present disclosure, where a graphical user interface is provided through a terminal device, and the content displayed by the graphical user interface includes a touch area. As shown in FIG. 8, the device includes the following modules.

An acquisition module 802 is configured to, in response to a controlled virtual character executing a first game behavior in a game scene, acquire a first sound value of the controlled virtual character before executing the first game behavior and a second sound value after executing the first game behavior, where the first sound value and the second sound value are pre-configured game parameters for characterizing the sound states of the controlled virtual character before and after the first game behavior is executed.

A determination module 804 is configured to, according to the first sound value and the second sound value, determine a target frame animation from a pre-configured multi-frame sound animation for characterizing sound volume, where the multi-frame sound animation includes all animation frames from a first animation frame corresponding to the minimum sound value to a second animation frame corresponding to the maximum sound value.

A control module 806 is configured to display a sound interface control in the graphical user interface, and to control the rendering and playing of the target frame animation in the sound interface control to prompt the change of the sound volume of the controlled virtual character during the execution of the first game behavior.

Alternatively, the control module 806 includes a matching unit, configured to obtain a target frame animation by matching the multi-frame sound animation according to the first sound value and the second sound value, and determine a first animation frame corresponding to the first sound value as an initial frame of the target frame animation, and determine a second animation frame corresponding to the second sound value as a last frame of the target frame animation; and a control unit, configured to control to render and play the target frame animation within the sound interface control.

Alternatively, the matching unit includes a mapping subunit configured to obtain a first sound animation and a second sound animation by mapping the first sound value and the second sound value to the multi-frame sound animation respectively.

Alternatively, the control module 806 further includes a display unit configured to render the preset display area in the sound interface control through a shader node so that the sound interface control plays the target frame animation.

Alternatively, the device further includes a second acquisition module configured to acquire multiple game behaviors pre-set for the controlled virtual character; a configuration module configured to configure game parameters of multiple game behaviors according to the sound states corresponding to the multiple game behaviors and the preset volume range, where the game parameters are configured to represent the sound states of the multiple game behaviors through sound values.

Alternatively, the device further includes a third acquisition module, configured to, in response to the controlled virtual character completing the first game behavior in the game scene, obtain an attenuation function corresponding to the first game behavior; an attenuation module, configured to obtain a third sound value by attenuation of the second sound value based on the attenuation function; a second determination module, configured to, according to the second sound value and the third sound value, determine a preset frame animation from a pre-configured multi-frame sound animation for characterizing the sound volume; and a second control module, configured to control to render and play the preset frame animation in the sound interface control.

Alternatively, the device further includes a construction module, configured to construct a texture coordinate system; a first processing module, configured to obtain an original transverse texture coordinate system and an original longitudinal texture coordinate system by executing operation processing on the texture coordinate system; an addition module, configured to obtain a target transverse texture coordinate system by adding a noise variable to the original transverse texture coordinate system; a second processing module, configured to obtain a target longitudinal texture coordinate system by processing on the original longitudinal texture coordinate system based on a preset absolute value; and a generating module, configured to generate the multi-frame sound animation based on the target transverse texture coordinate system and the target longitudinal texture coordinate system.

Alternatively, the addition module includes a first processing unit configured to obtain a first transverse texture coordinate system by processing the original transverse texture coordinate system based on the time variable, where the first transverse texture coordinate system changes based on the time variable; a second processing unit configured to obtain a second transverse texture coordinate system by processing the first transverse texture coordinate system based on a periodic function, where the second transverse texture coordinate system changes periodically based on the time variable; a third processing unit configured to obtain a third transverse texture coordinate system by processing the second transverse texture coordinate system based on the noise variable; and a fourth processing unit configured to obtain the target transverse texture coordinate system by processing the third transverse texture coordinate system based on a random number set.

Alternatively, the generating module includes a calculating unit configured to obtain the target texture coordinate system by adding the target longitudinal texture coordinate system and the target transverse texture coordinate system; and a generating unit configured to generate the multi-frame sound animation based on the target texture coordinate system.

Alternatively, the generating unit includes a processing subunit configured to obtain a smooth texture coordinate system by performing smooth processing on the target texture coordinate system using a smooth step function; a merging subunit configured to obtain a mask texture coordinate system by performing merging processing on the preset mask map and the smooth texture coordinate system, where a preset area of the preset mask map is an opaque area, and other areas of the preset mask map except the preset area are transparent areas; and an adjusting subunit configured to obtain a target texture coordinate system by performing adjustment on the mask texture coordinate system based on a transparency variable and a color variable, where the transparency variable is configured to adjust the transparency of the target texture coordinate system, and the color variable is configured to adjust the color of the target texture coordinate system.

Alternatively, the device further includes a third processing module configured to obtain a first texture coordinate system by processing the texture coordinate system using a first preset parameter; a fourth processing module configured to obtain a second texture coordinate system by processing the texture coordinate system using a second preset parameter, where the second preset parameter is different from the first preset parameter; a fifth processing module configured to obtain a first number set corresponding to the first texture coordinate system and a second number set corresponding to the second texture coordinate system by processing the first texture coordinate system and the second texture coordinate system according to the time variable and the preset time rolling parameter, respectively; and a calculation module configured to obtain a random number set by the product of the first number set and the second number set.

It should be noted that the above-mentioned units and modules can be implemented by software or hardware. For the latter, it can be implemented in the following ways, but not limited to this: the above-mentioned units and modules are all located in the same processor; or the above-mentioned units and modules are respectively located in different processors in any combination.

The embodiment of the present disclosure also provides a non-transitory storage medium, in which a computer program is stored. The computer program is configured to execute the steps of any of the above-mentioned method embodiments when running.

Alternatively, in this embodiment, the non-transitory storage medium may include but is not limited to U disk, read-only memory (ROM), random access memory (RAM), mobile hard disk, disk or optical disk and other media that can store computer programs.

Alternatively, in this embodiment, the non-transitory storage medium may be located in any computer terminal in a computer terminal group in a computer network, or in any mobile terminal in a mobile terminal group.

Alternatively, in this embodiment, the non-transitory storage medium may be configured to store a computer program for performing the following steps:

Alternatively, displaying a sound interface control in a graphical user interface, and controlling rendering and playing of a target frame animation in the sound interface control includes obtaining the target frame animation by matching the multi-frame sound animation according to a first sound value and a second sound value, and taking a first animation frame corresponding to the first sound value as an initial frame of the target frame animation, and taking a second animation frame corresponding to the second sound value as a last frame of the target frame animation; and controlling the rendering and playing of the target frame animation in the sound interface control.

Alternatively, according to the first sound value and the second sound value, the determining a first sound animation and a second sound animation from the multi-frame sound animation respectively includes obtaining the first sound animation and the second sound animation by mapping the first sound value and the second sound value to the multi-frame sound animation respectively.

Alternatively, displaying a sound interface control in a graphical user interface, and controlling the rendering and playing of the target frame animation in the sound interface control includes rendering the preset display area in the sound interface control through a shader node so that the sound interface control plays the target frame animation.

Alternatively, the method further includes obtaining multiple game behaviors pre-set for the controlled virtual character; configuring game parameters of multiple game behaviors according to the sound states and preset volume ranges corresponding to the multiple game behaviors, where the game parameters are configured to represent the sound states of the multiple game behaviors by sound values.

Alternatively, the method further includes, in response to the controlled virtual character completing the first game behavior in the game scene, obtaining an attenuation function corresponding to the first game behavior; obtaining a third sound value by attenuating the second sound value based on the attenuation function; determining a preset frame animation from a pre-configured multi-frame sound animation for characterizing the sound volume according to the second sound value and the third sound value; and controlling the rendering and playing of the preset frame animation in the sound interface control.

Alternatively, the method further includes constructing a texture coordinate system; obtaining an original transverse texture coordinate system and an original longitudinal texture coordinate system by performing computation processing on the texture coordinate system; obtaining a target transverse texture coordinate system by adding a noise variable to the original transverse texture coordinate system; obtaining a target longitudinal texture coordinate system by processing the original longitudinal texture coordinate system based on a preset absolute value; and generating a multi-frame sound animation based on the target transverse texture coordinate system and the target longitudinal texture coordinate system.

Alternatively, obtaining the target transverse texture coordinate system by adding a noise variable to the original transverse texture coordinate system includes obtaining a first transverse texture coordinate system by processing the original transverse texture coordinate system based on the time variable, where the first transverse texture coordinate system changes based on the time variable; obtaining a second transverse texture coordinate system by processing the first transverse texture coordinate system based on a periodic function, where the second transverse texture coordinate system changes periodically based on the time variable; obtaining a third transverse texture coordinate system by processing the second transverse texture coordinate system based on the noise variable; and obtaining the target transverse texture coordinate system by processing the third transverse texture coordinate system based on a random number set.

Alternatively, generating a multi-frame sound animation based on a target transverse texture coordinate system and a target longitudinal texture coordinate system includes obtaining a target texture coordinate system by adding the target longitudinal texture coordinate system and the target transverse texture coordinate system; and generating the multi-frame sound animation based on the target texture coordinate system.

Alternatively, generating a multi-frame sound animation based on a target texture coordinate system includes obtaining a smooth texture coordinate system by smoothing the target texture coordinate system using a smooth step function; obtaining a mask texture coordinate system by merging the preset mask map and the smooth texture coordinate system, where the preset area of the preset mask map is an opaque area, and other areas of the preset mask map except the preset area are transparent areas; obtaining the target texture coordinate system by adjusting the mask texture coordinate system based on the transparency variable and the color variable, where the transparency variable is configured to adjust the transparency of the target texture coordinate system, and the color variable is configured to adjust the color of the target texture coordinate system.

Alternatively, the method further includes obtaining a first texture coordinate system by processing the texture coordinate system using a first preset parameter; obtaining a second texture coordinate system by processing the texture coordinate system using a second preset parameter, where the second preset parameter is different from the first preset parameter; obtaining a first number set corresponding to the first texture coordinate system and a second number set corresponding to the second texture coordinate system by processing the first texture coordinate system and the second texture coordinate system respectively according to a time variable and a preset time scrolling parameter; and obtaining a random number set by multiplying the first number set and the second number set.

Alternatively, the non-transitory storage medium is further configured to store program codes for executing the following steps.

Alternatively, the non-transitory storage medium is further configured to store program codes for executing the following steps.

In the non-transitory storage medium of this embodiment, a technical solution is provided, in response to the controlled virtual character executing the first game behavior in the game scene, obtaining the first sound value of the controlled virtual character before executing the first game behavior and the second sound value after executing the first game behavior; where the first sound value and the second sound value are pre-configured game parameters for characterizing the sound states of the controlled virtual character before and after the first game behavior is executed; according to the first sound value and the second sound value, determining a target frame animation from the pre-configured multi-frame sound animation for characterizing the sound volume, where the multi-frame sound animation includes all animation frames from a first animation frame corresponding to the minimum sound value to a second animation frame corresponding to the maximum sound value; displaying a sound interface control in a graphical user interface, and controlling the rendering and playing of the target frame animation in the sound interface control to prompt the change in the sound volume of the controlled virtual character during the execution of the first game behavior. It is easy to notice that the game parameters for characterizing the sound states of the controlled virtual character before and after the first game behavior is executed, that is, the first sound value and the second sound value, can be pre-configured, and the multi-frame sound animation for representing the sound volume can be pre-configured at the same time. The target frame animation is determined based on the first sound value and the second sound value, so that the multi-frame sound animation can be adjusted, and the real-time acquisition of the audio data in the game can be avoided. Only by obtaining the game parameters of the sound states of the controlled virtual character before and after the first game behavior is executed, the simulated audio can be obtained, thereby realizing the visualization operation of the audio, and further solving the technical problem of low efficiency in the visualization operation of the audio in the related art.

Through the description of the above embodiments, it is easy for those skilled in the art to understand that the example embodiments described here can be implemented by software, or by combining software with necessary hardware. Therefore, the technical solution according to the embodiment of the present disclosure can be embodied in the form of a software product, which can be stored in a computer-readable storage medium (which can be a CD-ROM, a USB flash drive, a mobile hard disk, etc.) or on a network, and includes several instructions to enable a computing device (which can be a personal computer, a server, a terminal device, or a network device, etc.) to execute the method according to the embodiment of the present disclosure.

In the example embodiments of the present application, a program product capable of implementing the above method of the present embodiment is stored on a computer-readable storage medium. In some possible implementations, various aspects of the embodiments of the present disclosure may also be implemented in the form of a program product, which includes a program code. When the program product is run on a terminal device, the program code is configured to enable the terminal device to execute the steps described in the above “Example Method” section of the present embodiment according to various example implementations of the present disclosure.

According to the program product for implementing the above method according to the embodiment of the present disclosure, it can adopt a portable compact disk read-only memory (CD-ROM) and include program code, and can be run on a terminal device, such as a personal computer. However, the program product of the embodiment of the present disclosure is not limited to this. In the embodiment of the present disclosure, the computer-readable storage medium can be any tangible medium containing or storing a program, and the program can be used by or in combination with an instruction execution system, a device or a component.

The above program product can adopt any combination of one or more computer-readable media. The computer-readable storage medium can be, for example, but not limited to, an electrical, magnetic, optical, electromagnetic, infrared, or semiconductor system, device or component, or any combination of the above. More specific examples of computer-readable storage media (non-exhaustive enumeration) include: an electrical connection with one or more wires, a portable disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

It should be noted that the program code contained in the computer-readable storage medium can be transmitted by any appropriate medium, including but not limited to wireless, wired, optical cable, RF, etc., or any suitable combination of the above.

The embodiment of the present disclosure also provides an electronic device, including a memory and a processor, the memory stores a computer program, and the processor is configured to run the computer program to execute the steps in any of the above method embodiments.

Alternatively, the above electronic device may further include a transmission device and an input/output device. The transmission device is connected to the above processor, and the input/output device is connected to the above processor.

Alternatively, in this embodiment, the above processor may be configured to perform the following steps through a computer program:

Alternatively, displaying a sound interface control in a graphical user interface, and controlling rendering and playing of a target frame animation in the sound interface control includes obtaining the target frame animation by matching the multi-frame sound animation according to a first sound value and a second sound value, and taking a first animation frame corresponding to the first sound value as an initial frame of the target frame animation, and taking a second animation frame corresponding to the second sound value as a last frame of the target frame animation; and controlling the rendering and playing of the target frame animation in the sound interface control.

Alternatively, according to the first sound value and the second sound value, determining a first sound animation and a second sound animation from the multi-frame sound animation respectively includes obtaining the first sound animation and the second sound animation by mapping the first sound value and the second sound value to the multi-frame sound animation respectively.

Alternatively, displaying a sound interface control in a graphical user interface, and controlling the rendering and playing of the target frame animation in the sound interface control includes rendering the preset display area in the sound interface control through a shader node so that the sound interface control plays the target frame animation.

Alternatively, the method further includes obtaining multiple game behaviors pre-set for the controlled virtual character; configuring game parameters of multiple game behaviors according to the sound states and preset volume ranges corresponding to the multiple game behaviors, where the game parameters are configured to represent the sound states of the multiple game behaviors by sound values.

Alternatively, the method further includes, in response to the controlled virtual character completing the first game behavior in the game scene, obtaining an attenuation function corresponding to the first game behavior; obtaining a third sound value by attenuating the second sound value based on the attenuation function; determining a preset frame animation from a pre-configured multi-frame sound animation for characterizing the sound volume according to the second sound value and the third sound value; and controlling the rendering and playing of the preset frame animation in the sound interface control.

Alternatively, the method further includes constructing a texture coordinate system; obtaining an original transverse texture coordinate system and an original longitudinal texture coordinate system by performing computation processing on the texture coordinate system; obtaining a target transverse texture coordinate system by adding a noise variable to the original transverse texture coordinate system; obtaining a target longitudinal texture coordinate system by processing the original longitudinal texture coordinate system based on a preset absolute value; and generating a multi-frame sound animation based on the target transverse texture coordinate system and the target longitudinal texture coordinate system.

Alternatively, obtaining the target transverse texture coordinate system by adding a noise variable to the original transverse texture coordinate system includes obtaining a first transverse texture coordinate system by processing the original transverse texture coordinate system based on the time variable, where the first transverse texture coordinate system changes based on the time variable; obtaining a second transverse texture coordinate system by processing the first transverse texture coordinate system based on a periodic function, where the second transverse texture coordinate system changes periodically based on the time variable; obtaining a third transverse texture coordinate system by processing the second transverse texture coordinate system based on the noise variable; and obtaining the target transverse texture coordinate system by processing the third transverse texture coordinate system based on a random number set.

Alternatively, generating a multi-frame sound animation based on a target transverse texture coordinate system and a target longitudinal texture coordinate system includes obtaining a target texture coordinate system by adding the target longitudinal texture coordinate system and the target transverse texture coordinate system; and generating the multi-frame sound animation based on the target texture coordinate system.

Alternatively, generating a multi-frame sound animation based on a target texture coordinate system includes obtaining a smooth texture coordinate system by smoothing the target texture coordinate system using a smooth step function; obtaining a mask texture coordinate system by merging the preset mask map and the smooth texture coordinate system, where the preset area of the preset mask map is an opaque area, and other areas of the preset mask map except the preset area are transparent areas; obtaining the target texture coordinate system by adjusting the mask texture coordinate system based on the transparency variable and the color variable, where the transparency variable is configured to adjust the transparency of the target texture coordinate system, and the color variable is configured to adjust the color of the target texture coordinate system.

Alternatively, the method further includes obtaining a first texture coordinate system by processing the texture coordinate system using a first preset parameter; obtaining a second texture coordinate system by processing the texture coordinate system using a second preset parameter, where the second preset parameter is different from the first preset parameter; obtaining a first number set corresponding to the first texture coordinate system and a second number set corresponding to the second texture coordinate system by processing the first texture coordinate system and the second texture coordinate system respectively according to a time variable and a preset time scrolling parameter; and obtaining a random number set by multiplying the first number set and the second number set.

Alternatively, the processor can further be configured to perform the following steps through a computer program.

Alternatively, the processor can further be configured to perform the following steps through a computer program.

In the electronic device of this embodiment, a technical solution is provided, in response to the controlled virtual character performing a first game behavior in a game scene, obtaining a first sound value of the controlled virtual character before performing the first game behavior and a second sound value after performing the first game behavior; where the first sound value and the second sound value are pre-configured game parameters for characterizing the sound states of the controlled virtual character before and after the first game behavior is performed; according to the first sound value and the second sound value, determining a target frame animation from a pre-configured multi-frame sound animation for characterizing the sound volume, where the multi-frame sound animation includes all animation frames from a first animation frame corresponding to the minimum sound value to a second animation frame corresponding to the maximum sound value; displaying a sound interface control in a graphical user interface, and controlling the rendering and playing of the target frame animation in the sound interface control to prompt the change in the sound volume of the controlled virtual character during the execution of the first game behavior. It is easy to notice that the game parameters for characterizing the sound states of the controlled virtual character before and after the first game behavior is executed, that is, the first sound value and the second sound value, can be pre-configured, and the multi-frame sound animation for representing the sound volume can be pre-configured at the same time. The target frame animation is determined based on the first sound value and the second sound value, so that the multi-frame sound animation can be adjusted, and the real-time acquisition of audio data in the game can be avoided. Only by obtaining the game parameters of the sound states of the controlled virtual character before and after the first game behavior is executed, the simulated audio can be obtained, thereby realizing the visualization operation of the audio, and further solving the technical problem of low efficiency in the visualization operation of the audio in the related art.

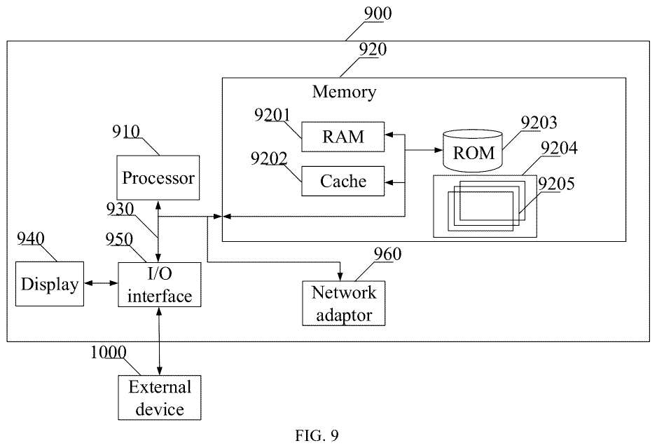

FIG. 9 is a schematic diagram of an electronic device according to an embodiment of the present disclosure. As shown in FIG. 9, the electronic device 900 is only an example and should not bring any limitation to the function and scope of use of the embodiment of the present disclosure.

As shown in FIG. 9, the electronic device 900 is presented in the form of a general computing device. The components of the electronic device 900 may include but are not limited to: the at least one processor 910 mentioned above, the at least one memory 920 mentioned above, a bus 930 connecting different system components (including the memory 920 and the processor 910), and a display 940.

The memory 920 stores program codes, which can be executed by the processor 910, so that the processor 910 executes the steps described in the method section of the embodiment of the present application according to various example embodiments of the present disclosure.

The memory 920 may include a readable medium in the form of a volatile storage unit, such as a random access storage unit (RAM) 9201 and/or a cache storage unit 9202, and may further include a read-only storage unit (ROM) 9203, and may also include a non-volatile memory, such as one or more magnetic storage devices, flash memory, or other non-volatile solid-state memory.

In some examples, the memory 920 may further include a program/utility 9204 having a set (at least one) of program modules 9205, such program modules 9205 include but are not limited to: an operating system, one or more application programs, other program modules, and program data, each of which or some combination of which may include the implementation of a network environment. The memory 920 may further include a memory remotely arranged relative to the processor 910, and the remote memory may be connected to the electronic device 900 via a network. Examples of the above-mentioned network include, but are not limited to, the Internet, an intranet, a local area network, a mobile communication network and combinations thereof.

The bus 930 may represent one or more of several types of bus structures, including a storage unit bus or storage unit controller, a peripheral bus, a graphics acceleration port, a processor 910, or a local bus using any of a variety of bus structures.

The display 940 may be, for example, a touch screen liquid crystal display (LCD), which may enable a user to interact with a user interface of the electronic device 900.

Alternatively, the electronic device 900 may also communicate with one or more external devices 1400 (e.g., a keyboard, a pointing device, a Bluetooth device, etc.), may also communicate with one or more devices that enable a user to interact with the electronic device 900, and/or may communicate with any device that enables the electronic device 900 to communicate with one or more other computing devices (e.g., a router, a modem, etc.). Such communication may be performed via an input/output (I/O) interface 950. Furthermore, the electronic device 900 may also communicate with one or more networks (e.g., a local area network (LAN), a wide area network (WAN), and/or a public network, such as the Internet) via a network adapter 960. As shown in FIG. 9, the network adapter 960 communicates with other modules of the electronic device 900 through the bus 930. It should be understood that, although not shown in FIG. 9, other hardware and/or software modules can be used in conjunction with the electronic device 900, including but not limited to: microcode, device drivers, redundant processing units, external disk drive arrays, RAID systems, tape drives, and data backup storage systems, etc.

The above-mentioned electronic device 900 may further include a keyboard, a cursor control device (such as a mouse), an input/output interface (I/O interface), a network interface, a power supply, and/or a camera.

Those skilled in the art can understand that the structure shown in FIG. 9 is only for illustration and does not limit the structure of the above-mentioned electronic device. For example, the electronic device 900 may further include more or fewer components than those shown in FIG. 9, or have a configuration different from that shown in FIG. 1. The memory 920 may be configured to store computer programs and corresponding data, such as the computer programs and corresponding data corresponding to the interactive animation processing method in the embodiment of the present disclosure. The processor 910 executes various functional applications and data processing, that is, implements the above-mentioned interactive animation processing method, by running the computer program stored in the memory 920.

The serial numbers in the above-mentioned embodiments of the present disclosure are only for description and do not represent the advantages and disadvantages of the embodiments.

In the above-mentioned embodiments of the present disclosure, the descriptions of each embodiment have their own emphasis. For parts that are not described in detail in a certain embodiment, please refer to the relevant descriptions of other embodiments.

In the several embodiments provided in this application, it should be understood that the disclosed technical content can be implemented in other ways. The device embodiments described above are only schematic. For example, the division of the units can be a logical function division. There may be other division methods in actual implementation, such as multiple units or components can be combined or integrated into another system, or some features can be ignored or not executed. Another point is that the mutual coupling or direct coupling or communication connection shown or discussed can be through some interfaces, indirect coupling or communication connection of units or modules can be electrical or other forms.

The units described as separate components may or may not be physically separated, and the components displayed as units may or may not be physical units, that is, they may be located in one place, or they may be distributed on multiple units. Some or all of the units can be selected according to actual needs to achieve the purpose of the scheme of this embodiment.

In addition, respective functional units in respective embodiments of the present disclosure may be integrated into a processing unit, or respective units may exist physically separately, or two or more units may be integrated into one unit. The above-mentioned integrated unit may be implemented in the form of hardware or in the form of a software functional unit.

If the integrated unit is implemented in the form of a software functional unit and sold or used as an independent product, it may be stored in a computer-readable storage medium. Based on this understanding, the technical solution of the present disclosure essentially or in part contributing to the related art or all or part of the technical solution can be embodied in the form of a software product, which is stored in a storage medium and includes several instructions for a computer device (which may be a personal computer, server or network device, etc.) to execute all or part of the steps of the method described in each embodiment of the present disclosure. The aforementioned storage medium includes U disk, read-only memory (ROM), random access memory (RAM), mobile hard disk, disk or optical disk, etc., which can store program code.

The above is only a preferred embodiment of the present disclosure. It should be pointed out that for those skilled in the art, several improvements and modifications can be made without departing from the principle of the present disclosure. These improvements and modifications should also be regarded as the scope of protection of the present disclosure.

1. A method for processing interactive animation, comprising:
providing a graphical user interface through a terminal device, wherein content displayed in the graphical user interface comprises at least part of a game scene, the game scene comprises a controlled virtual character;
in response to the controlled virtual character performing a first game behavior in the game scene, acquiring a first sound value of the controlled virtual character before the first game behavior is performed and a second sound value of the controlled virtual character after the first game behavior is performed, wherein the first sound value and the second sound value are pre-configured game parameters for characterizing sound states of the controlled virtual character before and after the first game behavior is performed;
according to the first sound value and the second sound value, determining a target frame animation from a pre-configured multi-frame sound animation for characterizing sound volume, wherein the multi-frame sound animation comprises all animation frames from a first animation frame corresponding to a minimum sound value to a second animation frame corresponding to a maximum sound value; and
prompting a change in the sound volume of the controlled virtual character during execution of the first game behavior by displaying a sound interface control in the graphical user interface and controlling to render and play the target frame animation in the sound interface control.

2. The method according to claim 1, wherein displaying the sound interface control in the graphical user interface, and controlling to render and play the target frame animation in the sound interface control comprises:
obtaining the target frame animation by matching the multi-frame sound animation according to the first sound value and the second sound value, and taking a first animation frame corresponding to the first sound value as an initial frame of the target frame animation, and taking a second animation frame corresponding to a second sound value as a last frame of the target frame animation; and
controlling to render and play the target frame animation in the sound interface control.

3. The method according to claim 2, wherein obtaining the target frame animation by matching the multi-frame sound animation according to the first sound value and the second sound value comprises:
obtaining a first sound animation and a second sound animation from the multi-frame sound animation
by mapping the first sound value and the second sound value to the multi-frame sound animation respectively; and
obtaining the target frame animation by the first sound animation and the second sound animation.

4. The method according to claim 1, wherein displaying the sound interface control in the graphical user interface, and controlling to render and play the target frame animation in the sound interface control comprises:
rendering a preset display area in the sound interface control through a shader node, wherein the sound interface control plays the target frame animation.

5. The method according to claim 1, further comprising:
acquiring a plurality of game behaviors pre-set for the controlled virtual character; and
configuring game parameters of the plurality of game behaviors according to sound states and preset volume ranges corresponding to the plurality of game behaviors, wherein the game parameters are configured to represent the sound states of the plurality of game behaviors by sound values.

6. The method according to claim 1, further comprising:
in response to the controlled virtual character completing the first game behavior in the game scene, acquiring an attenuation function corresponding to the first game behavior;
obtaining a third sound value by attenuating the second sound value based on the attenuation function;
determining a preset frame animation from the pre-configured multi-frame sound animation for characterizing the sound volume according to the second sound value and the third sound value; and
controlling to render and play the preset frame animation in the sound interface control.

7. The method according to claim 1, further comprising:
constructing a texture coordinate system;
obtaining an original transverse texture coordinate system and an original longitudinal texture coordinate system by performing computation processing on the texture coordinate system;
obtaining a target transverse texture coordinate system by adding a noise variable to the original transverse texture coordinate system;
obtaining a target longitudinal texture coordinate system by processing the original longitudinal texture coordinate system based on a preset absolute value; and
generating the multi-frame sound animation based on the target transverse texture coordinate system and the target longitudinal texture coordinate system.

8. The method according to claim 7, wherein obtaining the target transverse texture coordinate system by adding the noise variable to the original transverse texture coordinate system comprises:
obtaining a first transverse texture coordinate system by processing the original transverse texture coordinate system based on a time variable, wherein the first transverse texture coordinate system changes based on the time variable;
obtaining a second transverse texture coordinate system by processing the first transverse texture coordinate system based on a periodic function, wherein the second transverse texture coordinate system changes periodically based on the time variable;
obtaining a third transverse texture coordinate system by processing the second transverse texture coordinate system based on the noise variable; and
obtaining the target transverse texture coordinate system by processing the third transverse texture coordinate system based on a random number set.

9. The method according to claim 7, wherein generating the multi-frame sound animation based on the target transverse texture coordinate system and the target longitudinal texture coordinate system comprises:
obtaining a target texture coordinate system by adding the target longitudinal texture coordinate system and the target transverse texture coordinate system; and
generating the multi-frame sound animation based on the target texture coordinate system.

10. The method according to claim 9, wherein generating the multi-frame sound animation based on the target texture coordinate system comprises:
obtaining a smooth texture coordinate system by smoothing the target texture coordinate system using a smooth step function;
obtaining a mask texture coordinate system by combining a preset mask map and the smooth texture coordinate system, wherein a preset area of the preset mask map is an opaque area, and other areas of the preset mask map except the preset area are transparent areas; and
obtaining the target texture coordinate system by adjusting the mask texture coordinate system based on a transparency variable and a color variable, wherein the transparency variable is configured to adjust transparency of the target texture coordinate system, and the color variable is configured to adjust color of the target texture coordinate system.

11. The method according to claim 7, further comprising:
obtaining a first texture coordinate system by processing the texture coordinate system using a first preset parameter;
obtaining a second texture coordinate system by processing the texture coordinate system using a second preset parameter, wherein the second preset parameter is different from the first preset parameter;
obtaining a first number set corresponding to the first texture coordinate system and a second number set corresponding to the second texture coordinate system by processing the first texture coordinate system and the second texture coordinate system respectively according to a time variable and a preset time rolling parameter; and
obtaining a random number set by a product of the first number set and the second number set.

12. (canceled)

13. A non-transitory storage medium, wherein a computer program is stored in the non-transitory storage medium, and when the computer program is executed by a processor, the computer program is configured to:
provide a graphical user interface through a terminal device, wherein content displayed in the graphical user interface comprises at least part of a game scene, the game scene comprises a controlled virtual character;
in response to the controlled virtual character performing a first game behavior in the game scene, acquire a first sound value of the controlled virtual character before the first game behavior is performed and a second sound value of the controlled virtual character after the first game behavior is performed, wherein the first sound value and the second sound value are pre-configured game parameters for characterizing sound states of the controlled virtual character before and after the first game behavior is performed;
according to the first sound value and the second sound value, determine a target frame animation from a pre-configured multi-frame sound animation for characterizing sound volume, wherein the multi-frame sound animation comprises all animation frames from a first animation frame corresponding to a minimum sound value to a second animation frame corresponding to a maximum sound value; and
prompt a change in the sound volume of the controlled virtual character during execution of the first game behavior by displaying a sound interface control in the graphical user interface and controlling to render and play the target frame animation in the sound interface control.

14. An electronic device, comprising a memory and a processor, wherein the memory stores a computer program, and the processor is configured to:
provide a graphical user interface through a terminal device, wherein content displayed in the graphical user interface comprises at least part of a game scene, the game scene comprises a controlled virtual character;
in response to the controlled virtual character performing a first game behavior in the game scene, acquire a first sound value of the controlled virtual character before the first game behavior is performed and a second sound value of the controlled virtual character after the first game behavior is performed, wherein the first sound value and the second sound value are pre-configured game parameters for characterizing sound states of the controlled virtual character before and after the first game behavior is performed;
according to the first sound value and the second sound value, determine a target frame animation from a pre-configured multi-frame sound animation for characterizing sound volume, wherein the multi-frame sound animation comprises all animation frames from a first animation frame corresponding to a minimum sound value to a second animation frame corresponding to a maximum sound value; and
prompt a change in the sound volume of the controlled virtual character during execution of the first game behavior by displaying a sound interface control in the graphical user interface and controlling to render and play the target frame animation in the sound interface control.

15. The device according to claim 14, wherein displaying the sound interface control in the graphical user interface, and controlling to render and play the target frame animation in the sound interface control comprises:
obtaining the target frame animation by matching the multi-frame sound animation according to the first sound value and the second sound value, and taking a first animation frame corresponding to the first sound value as an initial frame of the target frame animation, and taking a second animation frame corresponding to a second sound value as a last frame of the target frame animation; and
controlling to render and play the target frame animation in the sound interface control.

16. The device according to claim 15, wherein obtaining the target frame animation by matching the multi-frame sound animation according to the first sound value and the second sound value comprises:
obtaining a first sound animation and a second sound animation from the multi-frame sound animation by mapping the first sound value and the second sound value to the multi-frame sound animation respectively; and
obtaining the target frame animation by the first sound animation and the second sound animation.

17. The device according to claim 14, wherein displaying the sound interface control in the graphical user interface, and controlling to render and play the target frame animation in the sound interface control comprises:
rendering a preset display area in the sound interface control through a shader node, wherein the sound interface control plays the target frame animation.

18. The device according to claim 14, wherein the processor is further configured to:
acquire a plurality of game behaviors pre-set for the controlled virtual character; and
configure game parameters of the plurality of game behaviors according to sound states and preset volume ranges corresponding to the plurality of game behaviors, wherein the game parameters are configured to represent the sound states of the plurality of game behaviors by sound values.

19. The device according to claim 14, wherein the processor is further configured to:
in response to the controlled virtual character completing the first game behavior in the game scene, acquire an attenuation function corresponding to the first game behavior;
obtain a third sound value by attenuating the second sound value based on the attenuation function;
determine a preset frame animation from the pre-configured multi-frame sound animation for characterizing the sound volume according to the second sound value and the third sound value; and
control to render and play the preset frame animation in the sound interface control.

20. The device according to claim 14, wherein the processor is further configured to:
construct a texture coordinate system;
obtain an original transverse texture coordinate system and an original longitudinal texture coordinate system by performing computation processing on the texture coordinate system;
obtain a target transverse texture coordinate system by adding a noise variable to the original transverse texture coordinate system;
obtain a target longitudinal texture coordinate system by processing the original longitudinal texture coordinate system based on a preset absolute value; and
generate the multi-frame sound animation based on the target transverse texture coordinate system and the target longitudinal texture coordinate system.

21. The device according to claim 20, wherein obtaining the target transverse texture coordinate system by adding the noise variable to the original transverse texture coordinate system comprises:
obtaining a first transverse texture coordinate system by processing the original transverse texture coordinate system based on a time variable, wherein the first transverse texture coordinate system changes based on the time variable;
obtaining a second transverse texture coordinate system by processing the first transverse texture coordinate system based on a periodic function, wherein the second transverse texture coordinate system changes periodically based on the time variable;
obtaining a third transverse texture coordinate system by processing the second transverse texture coordinate system based on the noise variable; and
obtaining the target transverse texture coordinate system by processing the third transverse texture coordinate system based on a random number set.
